(19) United States
(12) Patent Application Publication
(10) Pub. No.: US 2018/0039953 A1
(43) Pub. Date: Feb. 8, 2018

(54) LOCATION DISBURSEMENT COORDINATION SYSTEM

(71) Applicant: BANK OF AMERICA CORPORATION, Charlotte, NC (US)

(72) Inventors: Katherine Dintenfass, Lincoln, RI (US); Matthew Hsieh, Charlotte, NC (US); Wade Travis Hobbs, Mooresville, NC (US); Victoria L. Dravneek, Charlotte, NC (US)

(21) Appl. No.: 15/296,840

(22) Filed: Oct. 18, 2016

Related U.S. Application Data
(60) Provisional application No. 62/372,059, filed on Aug. 8, 2016.

(51) Int. Cl. G06Q 10/10; H04W 4/18; G06Q 50/14; H04L 29/06

(52) U.S. Cl. CPC G06Q 10/1095; H04L 67/42; H04W 4/18; G06Q 50/14

(57) ABSTRACT

Embodiments of the invention are directed to a system, method, or computer program product for location disbursement coordination. The invention generates a database integration with communication linkages for disbursement coordination for travel or relocation. Furthermore, the system identifying the travel or relocation requirements of a user and other individuals associated with the travel or relocation and the logistics for the same. The system identifies and stores contact information for third parties performing the requirements of the logistics. Furthermore, the invention communicates with the third parties for completion of disbursement coordination for logistics of the travel or relocation. The invention generates an interactive real-time coordination calendar system for storage and display on a mobile device and parses tasks associated with the travel or relocation and communicate the tasks to the user or the other individuals via the interactive real-time coordination calendar system.

### CROSS-REFERENCE OF RELATED APPLICATIONS

This application claims priority to U.S. Provisional Patent Application Ser. No. 62/372,059, filed Aug. 8, 2016, entitled “LOCATION DISBURSEMENT COORDINATION SYSTEM,” the entirety of which is incorporated herein by reference.

### BACKGROUND

With advancements in machine and product development, more and more machines and products are being interconnected via internet channels. These interconnections allow for system development and resource deployment avenues. Furthermore, the interconnectivity allows for large, multi-area data fields to be populated across entities.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address these and/or other needs by providing an innovative system, method and computer program product for enabling coordination of tasks, events and people in a family when taking a vacation or moving to a new location. A centralized calendar may be used to coordinate logistics such as who is responsible for particular tasks such as transportation, lodging, moving services, or the like. The invention may use as inputs flight, hotel, gas or the like pricing and predict pricing for various expenses and either send notifications to the user when prices are attractive or automatically purchase items upon criteria being met. Embodiments may enable changing billing addresses, taxes, insurance and the like to new addresses and/or stopping automatic payments for utilities at old location and setting up new utilities accounts and auto payment when moving to a new location. The invention can consider budget categories and make recommendations on transactions or recommend specific products/services/merchants/people to connect with, such as a new gym, people with like interests, playdates for kids, social activities/events, or the like. The application can also prioritize what you should do when you move into your new place, such as fix the broken cabinets, hire your landscapers or join the country club based on default criteria and/or user preferences. Services at the new location may be bundled for you by a financial institution (all utilities, grocery store, FSA, or the like).

Embodiments of the invention relate to systems, methods, and computer program products for location disbursement coordination, the invention comprising: generating a database integration with communication linkages for disbursement coordination for travel or relocation; identifying the travel or relocation requirements of a user and other individuals associated with the travel or relocation; identifying logistics for the travel or relocation and store contact information for third parties performing the requirements of the logistics; generating an interactive real-time coordination calendar system for storage and display on a mobile device; communicating with the third parties for completion of disbursement coordination for logistics of the travel or relocation; parsing tasks associated with the travel or relocation and communicate the tasks to the user or the other individuals via the interactive real-time coordination calendar system; and presenting notifications of the logistics of the travel or relocation.

In some embodiments, parsing tasks associated with the travel or relocation and communicate the tasks to the user or the other individuals via the interactive real-time coordination calendar system further comprises identifying the other individuals associated with the travel or relocation and linking the interactive real-time coordination calendar system onto a mobile device associated with the other individuals. In some embodiments, identifying the other individuals associated with the travel or relocation further comprises identifying individuals that are traveling or relocating with a user based on user input into the interactive real-time coordination calendar system, wherein communication with the mobile device associated with the other individual is performed by extracting the communication channel requirements for the mobile device associated with the other individual from the mobile device of the user.

In some embodiments, communicating with the third parties for completion of disbursement coordination for logistics of the travel or relocation further comprises identifying on the interactive real-time coordination calendar system a time and for the third parties completion of the disbursement coordination for logistics and contacting the third parties for completion of the disbursement coordination based on the interactive real-time coordination calendar system time for the third parties completion.

In some embodiments, parsing tasks associated with the travel or relocation and communicate the tasks to the user or the other individuals via the interactive real-time coordination calendar system further comprises removing tasks off of the interactive real-time coordination calendar system of the user and/or the other individuals upon identification of completion of the tasks.

In some embodiments, generating an interactive real-time coordination calendar system for storage and display on a mobile device further comprises identifying budget categories and presenting recommendations on travel or relocation.

In some embodiments, presenting notifications of the logistics of the travel or relocation further comprises identifying utilities, amenities, and insurance for the relocation and presenting notification of new utilities, amenities, and insurance to third party provider for set up of user for the new utilities, amenities, and insurance at the relocation.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a system environment in which embodiments of the invention operations, in accordance with one embodiment of the present invention;

FIG. 2 provides a high level process flow for location disbursement coordination, in accordance with one embodiment of the present invention;

FIG. 3 provides a process flow illustrating travel disbursement coordination, in accordance with one embodiment of the present invention; and

FIG. 4 provides a process flow illustrating location relocation disbursement coordination, in accordance with one embodiment of the present invention.

### DETAILED DESCRIPTION OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

An “account” is the relationship that a user has with an entity, such as a financial institution. Examples of accounts include a deposit account, such as a transactional account (e.g., a banking account), a savings account, an investment account, a money market account, a time deposit, a demand deposit, a pre-paid account, a credit account, a non-monetary user profile that includes information associated with the user, or the like. The account is associated with and/or maintained by the entity. “Assets” include accounts of the user and/or other property owned by the user. The assets may be associated with accounts or may be property that is not associated with a specific account. Examples of assets associated with accounts may be accounts that have cash or cash equivalents, or accounts that are funded with or contain property, such as safety despots box account that jewelry, a trust account that is funded with property, or the like. Examples of assets that may not be associated with accounts may be antiques in a user's home, jewelry in a user's home, or the like. “Authentication information” is any information that can be used to identify of a user. For example, a system may prompt a user to enter authentication information such as a username, a password, a personal identification number (PIN), a passcode, biometric information (e.g., voice authentication, a fingerprint, and/or a retina scan), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. An “entity” as used herein may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. A “financial institution” is any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. A “financial event” or “life event” may be any immediate or future event that causes a change in a user's financial status. A financial event may be a charge, a transaction, and exchange, or the like that may cause the user to lose or gain money and/or assets. Examples of financial events or life events include a medical expense, buying a house, college tuition, rent, and the like. To “monitor” is to watch, observe, or check something for a special purpose over a period of time. The “monitoring” may occur periodically over the period of time, or the monitoring may occur continuously over the period of time. In some embodiments, a system may actively monitor a database, wherein the system reaches out to the database and watches, observes, or checks the database for changes, updates, and the like. In other embodiments, a system may passively monitor a database, wherein the database provides information to the system and the system then watches, observes, or checks the provided information. A “transaction” refers to any communication between a user and the financial institution or other entity monitoring the user's activities. For example, a transaction may refer to a purchase of goods or services, a return of goods or services, a payment transaction, a credit transaction, or other interaction involving a user's account. In the context of a financial institution, a transaction may refer to one or more of: a sale of goods and/or services, initiating an automated teller machine (ATM) or online banking session, an account balance inquiry, a rewards transfer, an account money transfer or withdrawal, opening a bank application on a user's computer or mobile device, a user accessing their e-wallet, or any other interaction involving the user and/or the user's device that is detectable by the financial institution. A transaction may include one or more of the following: renting, selling, and/or leasing goods and/or services (e.g., groceries, stamps, tickets, DVDs, vending machine items, and the like); making payments to creditors (e.g., paying monthly bills; paying federal, state, and/or local taxes; and the like); sending remittances; loading money onto stored value cards (SVCs) and/or prepaid cards; donating to charities; and/or the like. A “user” may be a financial institution customer (e.g., an account holder or a person who have an account (e.g., banking account, credit account, or the like)). In one aspect, a user may be any financial institution customer involved in retirement planning with the financial institution or any other affiliate entities associated with the financial institution. In some embodiments, the user may be an individual who may be interested in opening an account with the financial institution. In some other embodiments, a user may be any individual who may be interested in enrolling in the retirement plan offered by the financial institution. In some embodiments, a “user” may be a financial institution employee (e.g., an underwriter, a project manager, an IT specialist, a manager, an administrator, an internal operations analyst, bank teller or the like) capable of operating the system described herein. For purposes of this invention, the term “user” and “customer” may be used interchangeably. A “user interface” is any device or software that allows a user to input information, such as commands or data, into a device, or that allows the device to output information to the user. For example, the user interface include a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users. Finally, the terms house, home, or property may refer to one or more real-estate or parcels of land.

Embodiments of the present invention address these and/or other needs by providing an innovative system, method and computer program product for location disbursement coordination. Embodiments of the present invention address these and/or other needs by providing an innovative system, method and computer program product for enabling coordination of tasks, events and people in a family when taking a vacation or moving to a new location. A centralized calendar may be used to coordinate logistics such as who is responsible for particular tasks such as transportation, lodging, moving services, or the like. The invention may use as inputs flight, hotel, gas or the like pricing and predict pricing for various expenses and either send notifications to the user when prices are attractive or automatically purchase items upon criteria being met. Embodiments may enable changing billing addresses, taxes, insurance and the like to new addresses and/or stopping automatic payments for utilities at old location and setting up new utilities accounts and auto payment when moving to a new location. The invention can consider budget categories and make recommendations on transactions or recommend specific products/services/merchants/people to connect with, such as a new gym, people with like interests, playdates for kids, social activities/events, or the like. The application can also prioritize what you should do when you move into your new place, such as fix the broken cabinets, hire your landscapers or join the country club based on default criteria and/or user preferences. Services at the new location may be bundled for you by a financial institution (all utilities, grocery store, FSA, or the like).

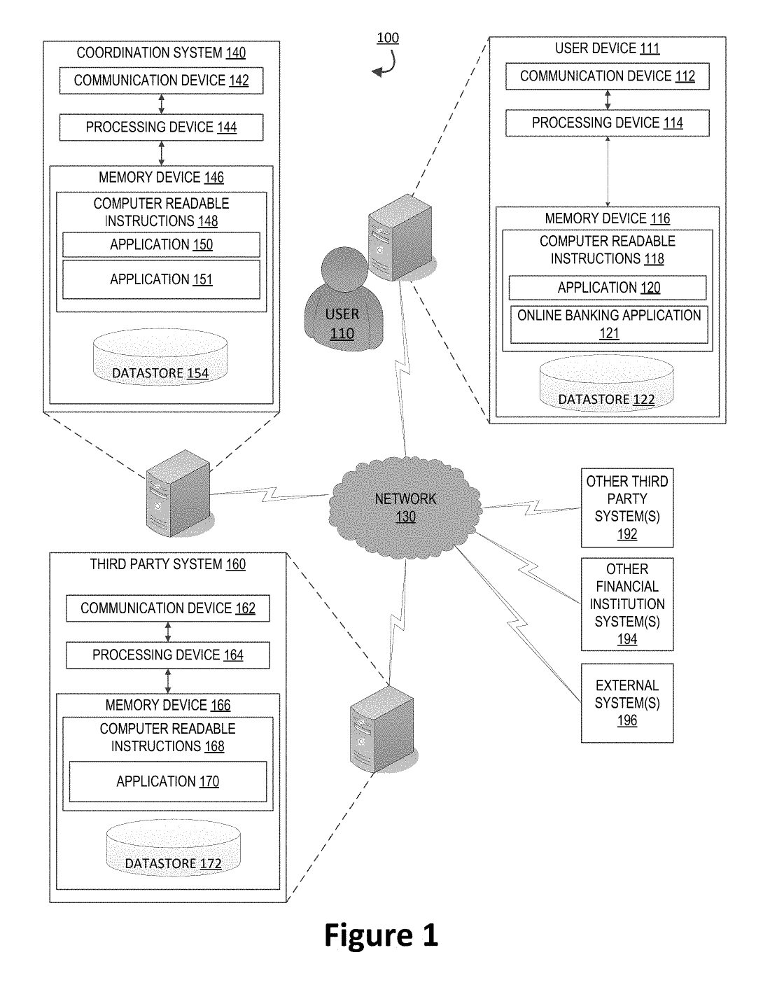

Referring now to FIG. 1, the figure illustrates a processing system environment 100, in accordance with some embodiments of the invention. The environment 100 includes a user device 111 associated or used with authorization of a user 110 (e.g., an account holder, a mobile application user, a bank customer, and the like), a third party system 160, and a coordination system 140. In some embodiments, the third party system 160 corresponds to a third party financial institution. The environment 100 further includes one or more third party systems 192 (e.g., a partner, agent, or contractor associated with a financial institution), one or more other financial institution systems 194 (e.g., a credit bureau, third party banks, and so forth), and one or more external systems 196.

The systems and devices communicate with one another over the network 130 and perform one or more of the various steps and/or methods according to embodiments of the disclosure discussed herein. The network 130 may include a local area network (LAN), a wide area network (WAN), and/or a global area network (GAN). The network 230 may provide for wireline, wireless, or a combination of wireline and wireless communication between devices in the network. In one embodiment, the network 130 includes the Internet.

The user device 111, the third party system 160, and the coordination system 140 each includes a computer system, server, multiple computer systems and/or servers or the like. The coordination system 140, in the embodiments shown has a communication device 142 communicably coupled with a processing device 144, which is also communicably coupled with a memory device 146. The processing device 144 is configured to control the communication device 142 such that the coordination system 140 communicates across the network 130 with one or more other systems. The processing device 144 is also configured to access the memory device 146 in order to read the computer readable instructions 148, which in some embodiments includes one or more applications such as applications 150 and 151. The memory device 146 also includes a datastore 154 or database for storing pieces of data that can be accessed by the processing device 144.

As used herein, a “processing device,” generally refers to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device 114, 144, or 164 may further include functionality to operate one or more software programs based on computer-executable program code thereof, which may be stored in a memory. As the phrase is used herein, a processing device 114, 144, or 164 may be “configured to” perform a certain function in a variety of ways, including, for example, by having one or more general-purpose circuits perform the function by executing particular computer-executable program code embodied in computer-readable medium, and/or by having one or more application-specific circuits perform the function.

Furthermore, as used herein, a “memory device” generally refers to a device or combination of devices that store one or more forms of computer-readable media and/or computer-executable program code/instructions. Computer-readable media is defined in greater detail below. For example, in one embodiment, the memory device 146 includes any computer memory that provides an actual or virtual space to temporarily or permanently store data and/or commands provided to the processing device 144 when it carries out its functions described herein.

The user device 111 includes a communication device 112 communicably coupled with a processing device 114, which is also communicably coupled with a memory device 116. The processing device 114 is configured to control the communication device 112 such that the user device 111 communicates across the network 130 with one or more other systems. The processing device 114 is also configured to access the memory device 116 in order to read the computer readable instructions 118, which in some embodiments includes application 120 and online banking application 121. The memory device 116 also includes a datastore 122 or database for storing pieces of data that can be accessed by the processing device 114. The user device 111 may be a mobile device of the user 110, a bank teller device, a third party device, an automated teller machine, a video teller machine, or another device capable of capturing a check image.

The third party system 160 includes a communication device 162 communicably coupled with a processing device 164, which is also communicably coupled with a memory device 166. The processing device 164 is configured to control the communication device 162 such that the third party system 160 communicates across the network 130 with one or more other systems. The processing device 164 is also configured to access the memory device 166 in order to read the computer readable instructions 168, which in some embodiments includes an application 170. The memory device 166 also includes a datastore 172 or database for storing pieces of data that can be accessed by the processing device 164.

In some embodiments, the application 120, the online banking application 121, and the application 170 interact with the application 150 or 151 to receive or provide financial data, analyze financial record data, and implement business strategies, transactions, and processes. The applications 150 and 151 may be a suite of applications for performing these functions.

In some embodiments, the application 120, the online banking application 121, and the application 170 interact with the applications 150 and 151 to utilize metadata to determine decisions for processing.

The applications 120, 121, 150, 151, and 170 are for instructing the processing devices 114, 144 and 164 to perform various steps of the methods discussed herein, and/or other steps and/or similar steps. In various embodiments, one or more of the applications 120, 121, 150, 151, and 170 are included in the computer readable instructions stored in a memory device of one or more systems or devices other than the systems 160 and 140 and the user device 111. For example, in some embodiments, the application 120 is stored and configured for being accessed by a processing device of one or more third party systems 192 connected to the network 130. In various embodiments, the applications 120, 121, 150, 151, and 170 stored and executed by different systems/devices are different. In some embodiments, the applications 120, 121, 150, 151, and 170 stored and executed by different systems may be similar and may be configured to communicate with one another, and in some embodiments, the applications 120, 121, 150, 151, and 170 may be considered to be working together as a singular application despite being stored and executed on different systems.

In various embodiments, one of the systems discussed above, such as the coordination system 140, is more than one system and the various components of the system are not collocated, and in various embodiments, there are multiple components performing the functions indicated herein as a single device. For example, in one embodiment, multiple processing devices perform the functions of the processing device 144 of the coordination system 140 described herein. In various embodiments, the coordination system 140 includes one or more of the external systems 196 and/or any other system or component used in conjunction with or to perform any of the method steps discussed herein. For example, the coordination system 140 may include a financial institution system, a credit agency system, and the like.

In various embodiments, the coordination system 140, the third party system 160, and the user device 111 and/or other systems may perform all or part of a one or more method steps discussed above and/or other method steps in association with the method steps discussed above. Furthermore, some or all the systems/devices discussed here, in association with other systems or without association with other systems, in association with steps being performed manually or without steps being performed manually, may perform one or more of the steps of one or more of the method discussed herein, or other methods, processes or steps discussed herein or not discussed herein.

Embodiments of the present invention address these and/or other needs by providing an innovative system, method and computer program product for enabling coordination of tasks, events and people in a family when taking a vacation or moving to a new location. A centralized calendar may be used to coordinate logistics such as who is responsible for particular tasks such as transportation, lodging, moving services, or the like. The invention may use as inputs flight, hotel, gas or the like pricing and predict pricing for various expenses and either send notifications to the user when prices are attractive or automatically purchase items upon criteria being met. Embodiments may enable changing billing addresses, taxes, insurance and the like to new addresses and/or stopping automatic payments for utilities at old location and setting up new utilities accounts and auto payment when moving to a new location. The invention can consider budget categories and make recommendations on transactions or recommend specific products/services/merchants/people to connect with, such as a new gym, people with like interests, playdates for kids, social activities/events, or the like. The application can also prioritize what you should do when you move into your new place, such as fix the broken cabinets, hire your landscapers or join the country club based on default criteria and/or user preferences. Services at the new location may be bundled for you by a financial institution (all utilities, grocery store, FSA, or the like).

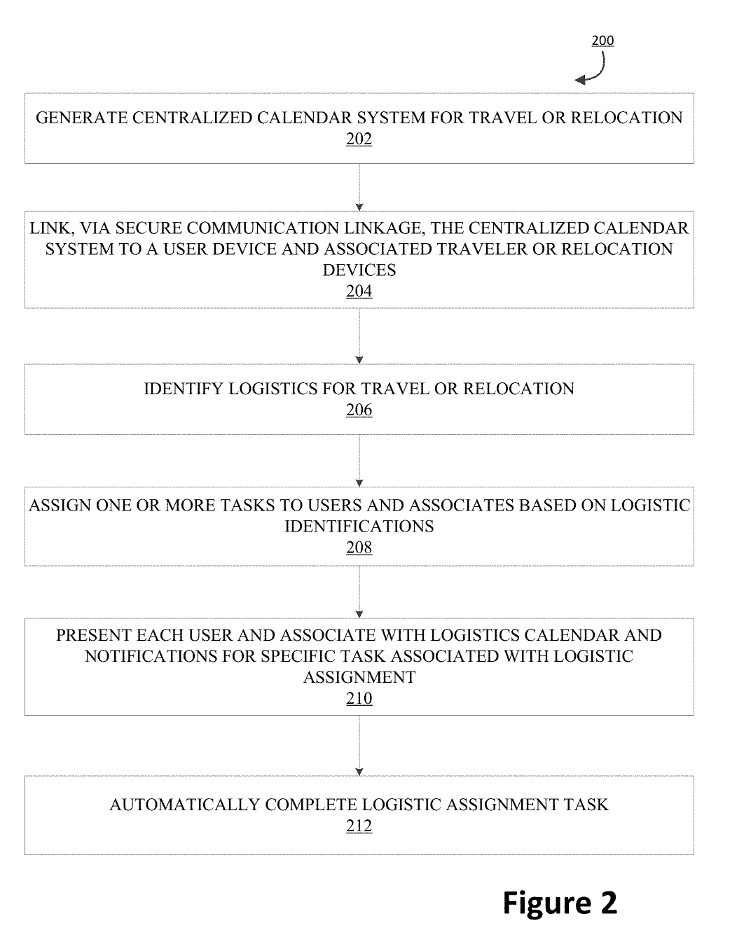

FIG. 2 illustrates a high level process flow for location disbursement coordination 200, in according to some embodiments of the invention. The first step, as represented by block 202, is to generate a centralized calendar system for travel or relocation location disbursement coordination. The centralized calendar system may store, associate, and queue the logistics for the relocation and/or travel. Next, as illustrated in block 204, the process continues by linking, via a secure communication linkage, the centralized calendar system to a user device and associated traveler or relocation devices. As such, the user performing the travel or relocation may be linked to the calendar system. Furthermore, other individual and entity devices associated with the travel or relocation, such as other individuals performing the travel or relocation, entities associated with the travel or relocation, such as travel agents, airlines, taxies, hotels, real-estate agents, utility companies, moving companies, or the like.

Next, as illustrated in block 206, the process 200 continues by identifying the logistics for the travel or the relocation. As such, the system may identify the travel or the relocation that may occur. Furthermore, the system may identify the travel or the relocation logistics. For example, for travel, the system may identify airlines, taxies, hotels, restaurants, events, locations, sites, admissions, and/or the like. For example, for relocation, the system may identify real-estate agents, movers, utility companies, restaurants, gyms, country clubs, grocery stores, general stores, and the like that are similar to the user's currently selected options at his/her current location.

As illustrated in block 208, the process 200 continues by assigning one or more tasks identified by the system for the travel and/or relocation to the users and/or the associates based on the logistic identifications. As such, the logistic identifications determined by the system may be presented for user or associate acceptance and performance. Based on the user, the system may assign various users and/or associates to tasks for completion and timing for the completion of the task for the travel or relocation. The task may include purchasing of products, reservation of events, reservations of hotels, reservations of restaurants, scheduling, ordering, reserving, moving, packing, organizing, or the like.

Next, as illustrated in block 210, the process 200 continues by presenting each user and associate with logistics calendars and notification for the specific task associated with the logistic assignment. As such, the system may link to and control the user or associate mobile device. In this way, the system may present the user and associate with the logistics associated with the user and timing of the tasks assigned to the user or associate. Furthermore, the system may present notifications for the tasks required by the user or associates. The tasks may include, but are not limited to scheduling, packing, reservations, or the like.

Finally, as illustrated in block 212, the process 200 continues by automatically complete the logistic assignments for the user or associates. In this way, the system may contact third party systems for completion of the logistic assignments for the user or associates. As such, the system may contact third parties and communicate the logistics such that the system may complete the logistics prior to the travel or relocation.

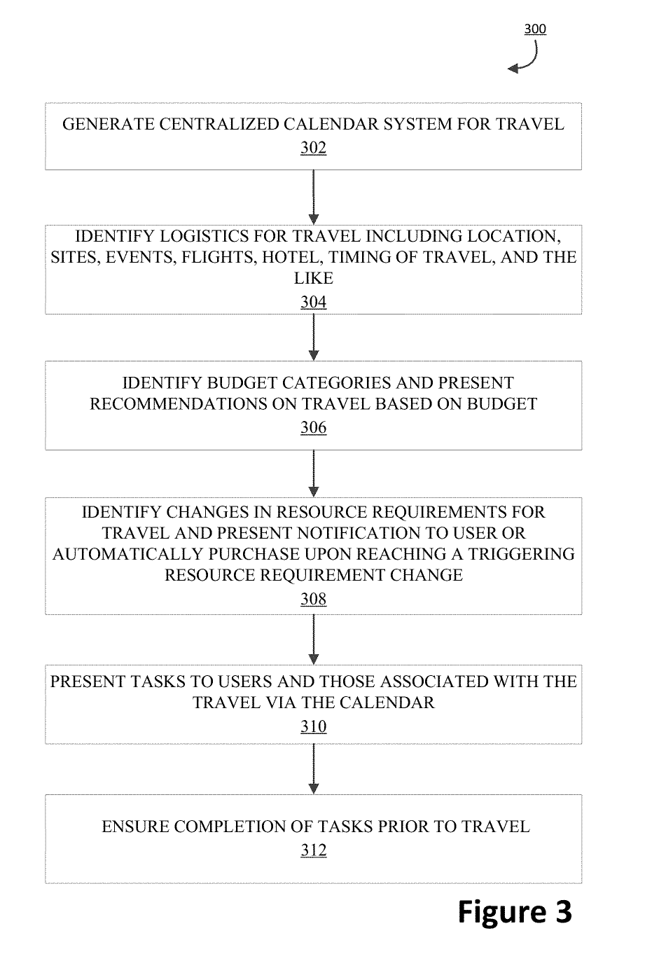

FIG. 3 provides a process flow illustrating travel disbursement coordination 300, in accordance with one embodiment of the present invention. The first step, as represented by block 302, is to generate a centralized calendar system for travel location disbursement coordination. The centralized calendar system may store, associate, and queue the logistics for the travel. In some embodiments, the system may link, via a secure communication linkage, the centralized calendar system to a user device and associated traveler devices. As such, the user performing the traveling may be linked to the calendar system. Furthermore, other individual and entity devices associated with the travel, such as other individuals performing the travel, entities associated with the travel, such as travel agents, airlines, taxies, hotels, real-estate agents, utility companies, or the like.

Next, as illustrated in block 304, the process 300 continues by identifying logistics for travel. The logistics for travel may include, but is not limited to the location being traveled to, the sites within the location, the events attending, flights, hotels, timing of travel, or the like. In this way, the system may identify and aggregate all of the possible requirements for the user's travel. The possible requirements are logged as logistics within the system for completion of the logistical requirements for the travel.

As illustrated in block 306, the process 300 continues by identifying budget categories and present recommendations on the travel based on the budget. In this way, the user may present a budget for one or more aspects of the travel to the system for utilization. In other embodiments, the system may receive an overall budget for the travel from the user. In yet other embodiments, the system may identify the user's travel trends and travel expense trends and generate a budget for the user based on the identified trends. The user may subsequently monitor and modify the budget at any time.

As illustrated in block 308, the process 300 continues by identifying changes in resource requirements for the travel and present notifications to the user or automatically purchase a required travel item upon reaching a triggering resource requirement change threshold. As such, as travel expenses, such as lodging, airfare, reservations, event tickets, and the like fluctuate over time, the system may monitor the user selected expenses and identify a price drop in those items. The identified changes may be provided to the user via a notification from the calendar system. In other embodiments, upon a price drop of one of the logistic requirements, the system may trigger an automatic purchase of the item for the travel. As such, the system may physically purchase an airline ticket, hotel, or the like for the user based on the identified triggering price drop.

Once the travel has been identified and the logistics have been planned for the same, the system may present tasks to users and those associated with the travel, via the calendar system, as illustrated in block 310. As such, tasks may be parsed or distributed among individuals traveling for shared responsibility of the tasks for the travel. The system may generate individual calendars and reminders for each traveler. Finally, as illustrated in block 312, the process 300 is completed upon the system ensuring that the tasks and logistics have been finalized prior to travel. The system may send notifications to the user, other travelers, or third parties upon identification of non-complete tasks for the travel.

In some embodiments, the invention may insert and embed a tokenized authorization to give the right to another individual to purchase one or more items from the task in order to complete the task. The token may allow an individual to use the user's account or a generic account to purchase the items for the completion of the task. In this way, the individual may pass payments from the individual to the user or to the group associated with the relocation or travel.

In some embodiments, once all of the tasks have been completed the system may calculate a total resource requirement for the relocation or travel and divide the resource allocation across the user and other individuals based on user preferences. Furthermore, any rewards, rebates, or the like associated with the purchases associated with the tasks may be applied to each user and individual associated with the relocation or travel. For example, if travel points are awarded for purchasing airline tickets, those points may be divided and used by all the individuals associated with the travel or relocation.

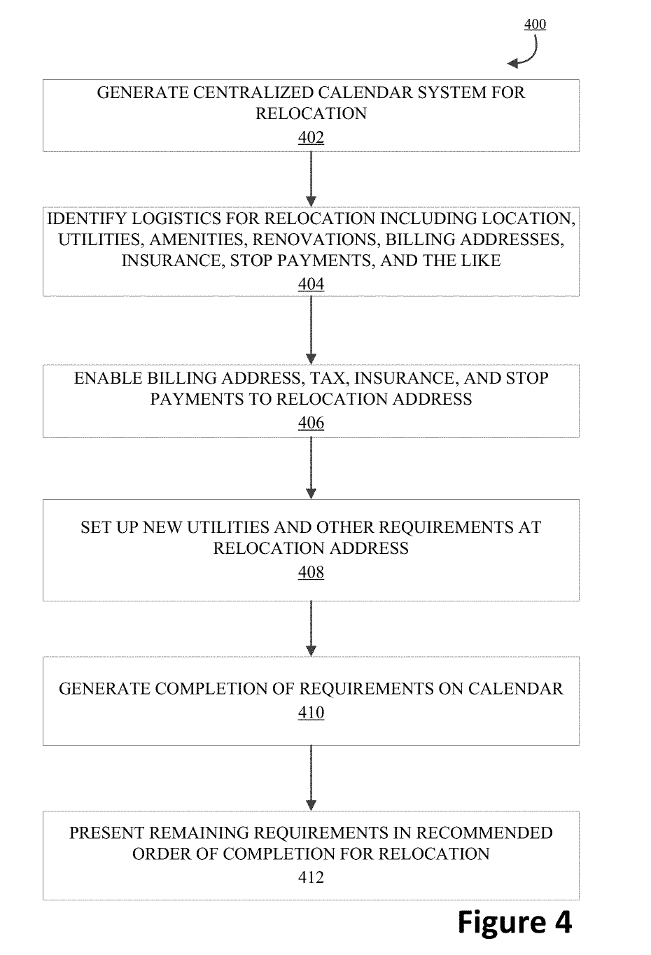

FIG. 4 provides a process flow illustrating location relocation disbursement coordination 400, in accordance with one embodiment of the present invention. The first step, as represented by block 402, is to generate a centralized calendar system for relocation location disbursement coordination. The centralized calendar system may store, associate, and queue the logistics for the relocation. In some embodiments, the system may link, via a secure communication linkage, the centralized calendar system to a user device and associated relocation devices such as family member devices or third party entity devices that are associated with the relocation. These third party entities may include a mover, employer, real-estate agent, utilities companies, remodelers, landscapers, decorators, local restaurants, stores, gyms or the like.

Next, as illustrated in block 404, the process 400 continues by identifying logistics for the relocation. The logistics for relocation may include, but are not limited to the location being relocated to, utility requirements, amenity requirements, renovation requirements, address change requirements, insurance, stop payment requirements, real-estate agents, movers, brokers, or the like. In this way, the system may identify and aggregate all of the possible requirements for the user's relocation. The possible requirements are logged as logistics within the system for completion of the logistical requirements for the relocation.

Next, as illustrated in block 406, the process 400 continues by enabling the billing address, tax, insurance, and stop payments to be transferred to the new relocation address. In this way, the system may present the required information to the necessary third party systems in order to facilitate the change in address for billing of various products of the user such as magazines, automatic bill pay, financial institutions, and the like. Furthermore, the system may generate and provide the necessary information to third parties for tax transfers, insurance for the relocation, stop payments to the previous address, and the like.

As illustrated in block 408, the process 400 continues by setting up the new utilities and other requirements at the relocation address. As such, the system may communicate with the third party systems to provide the information necessary for the user to transition into a new location and have the utilities and other services ready. Next, as illustrated in block 410, the process 400 continues by generating a completion of the requirements on the calendar.

Finally, as illustrated in block 412, the process 400 is completed by presenting the remaining requirements in recommended order for completion of the relocation. As such, the system may present via a display on the mobile device of the user, the recommended order of completion for the remaining requirements.

Embodiments of the present invention address these and/or other needs by providing an innovative system, method and computer program product for enabling coordination of tasks, events and people in a family when taking a vacation or moving to a new location. A centralized calendar may be used to coordinate logistics such as who is responsible for particular tasks such as transportation, lodging, moving services, or the like. The invention may use as inputs flight, hotel, gas or the like pricing and predict pricing for various expenses and either send notifications to the user when prices are attractive or automatically purchase items upon criteria being met. Embodiments may enable changing billing addresses, taxes, insurance and the like to new addresses and/or stopping automatic payments for utilities at old location and setting up new utilities accounts and auto payment when moving to a new location. The invention can consider budget categories and make recommendations on transactions or recommend specific products/services/merchants/people to connect with, such as a new gym, people with like interests, playdates for kids, social activities/events, or the like. The application can also prioritize what you should do when you move into your new place, such as fix the broken cabinets, hire your landscapers or join the country club based on default criteria and/or user preferences. Services at the new location may be bundled for you by a financial institution (all utilities, grocery store, FSA, or the like).

It should be understood, that the systems and devices described in FIG. 1, or other devices not specifically described herein, may be configured to establish a communication link with each other in order to accomplish the steps of the processes described herein. The link may be an internal link within the same entity (e.g., within the same financial institution or device provider) or a link with the other systems of entities (e.g., social networking systems, third-party systems, or the like). In some embodiments, the systems may be configured for monitoring the applications and devices that the system(s) utilize as data sources. The information received from monitoring may be provided via wireless network path portions through the Internet. When the systems or devices are not monitoring a source or are not being monitoring, the information need not be transmitted from the source through the Internet to the destination, although it could be. The sources of information may be made continuously available, however, continuously available does not necessarily mean that the sources actually continuously generates data, but that a source is continuously available to generate and send data real-time (e.g., instantaneously and/or within a few seconds, or the like) of receiving a request for it. In any case, the sources may be continuously available to receive and/or generate information, in some cases in digitized data in Internet Protocol (IP) packet format. In response to continuously monitoring the real-time data feeds from the various systems or devices, the system may be configured to provide target information to the user and/or allow the user to make changes to or control the applications and/or devices.

Moreover, it should be understood that the process flows described herein include transforming the information sent and/or received from the applications of the different systems (e.g., internally or externally) and/or the devices from one or more data formats into a data format associated with an application for display to the user on the user device. There are many ways in which information is converted within the system environment. This may be seamless, as in the case of upgrading to a newer version of a computer program. Alternatively, the conversion may require processing by the use of a special conversion program, or it may involve a complex process of going through intermediary stages, or involving complex “exporting” and “importing” procedures, which may converting to and from a tab-delimited or comma-separated text file. In some cases, a program may recognize several data file formats at the data input stage and then is also capable of storing the output data in a number of different formats. Such a program may be used to convert a file format. If the source format or target format is not recognized, then at times a third program may be available which permits the conversion to an intermediate format, which can then be reformatted.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for location disbursement coordination, the system comprising:
at least one memory device;
at least one communication device connected to a distributed network;
at least one processing device operatively coupled to the at least one memory device and the at least one communication device; and
a module stored in the at least one memory device comprising executable instructions that when executed by the at least one processing device, cause the at least one processing device to:
generate a database integration with communication linkages for disbursement coordination for travel or relocation;
identify the travel or relocation requirements of a user and other individuals associated with the travel or relocation;
identify logistics for the travel or relocation and store contact information for third parties performing the requirements of the logistics;
generate an interactive real-time coordination calendar system for storage and display on a mobile device;
communicate with the third parties for completion of disbursement coordination for logistics of the travel or relocation;
parse tasks associated with the travel or relocation and communicate the tasks to the user or the other individuals via the interactive real-time coordination calendar system; and
present notifications of the logistics of the travel or relocation.

2. The system of claim 1, wherein parsing tasks associated with the travel or relocation and communicate the tasks to the user or the other individuals via the interactive real-time coordination calendar system further comprises identifying the other individuals associated with the travel or relocation and linking the interactive real-time coordination calendar system onto a mobile device associated with the other individuals.

3. The system of claim 2, wherein identifying the other individuals associated with the travel or relocation further comprises identifying individuals that are traveling or relocating with a user based on user input into the interactive real-time coordination calendar system, wherein communication with the mobile device associated with the other individual is performed by extracting the communication channel requirements for the mobile device associated with the other individual from the mobile device of the user.

4. The system of claim 1, wherein communicating with the third parties for completion of disbursement coordination for logistics of the travel or relocation further comprises identifying on the interactive real-time coordination calendar system a time and for the third parties completion of the disbursement coordination for logistics and contacting the third parties for completion of the disbursement coordination based on the interactive real-time coordination calendar system time for the third parties completion.

5. The system of claim 1, wherein parsing tasks associated with the travel or relocation and communicate the tasks to the user or the other individuals via the interactive real-time coordination calendar system further comprises removing tasks off of the interactive real-time coordination calendar system of the user and/or the other individuals upon identification of completion of the tasks.

6. The system of claim 1, wherein generating an interactive real-time coordination calendar system for storage and display on a mobile device further comprises identifying budget categories and presenting recommendations on travel or relocation.

7. The system of claim 1, wherein presenting notifications of the logistics of the travel or relocation further comprises identifying utilities, amenities, and insurance for the relocation and presenting notification of new utilities, amenities, and insurance to third party provider for set up of user for the new utilities, amenities, and insurance at the relocation.

8. A computer program product for location disbursement coordination, the computer program product comprising at least one non-transitory computer readable medium having computer-readable program code portions embodied therein, the computer-readable program code portions comprising:
an executable portion configured for generating a database integration with communication linkages for disbursement coordination for travel or relocation;
an executable portion configured for identifying the travel or relocation requirements of a user and other individuals associated with the travel or relocation;
an executable portion configured for identifying logistics for the travel or relocation and store contact information for third parties performing the requirements of the logistics;
an executable portion configured for generating an interactive real-time coordination calendar system for storage and display on a mobile device;
an executable portion configured for communicating with the third parties for completion of disbursement coordination for logistics of the travel or relocation;
an executable portion configured for parsing tasks associated with the travel or relocation and communicate the tasks to the user or the other individuals via the interactive real-time coordination calendar system; and
an executable portion configured for presenting notifications of the logistics of the travel or relocation.

9. The computer program product of claim 8, wherein parsing tasks associated with the travel or relocation and communicate the tasks to the user or the other individuals via the interactive real-time coordination calendar system further comprises identifying the other individuals associated with the travel or relocation and linking the interactive real-time coordination calendar system onto a mobile device associated with the other individuals.

10. The computer program product of claim 9, wherein identifying the other individuals associated with the travel or relocation further comprises identifying individuals that are traveling or relocating with a user based on user input into the interactive real-time coordination calendar system, wherein communication with the mobile device associated with the other individual is performed by extracting the communication channel requirements for the mobile device associated with the other individual from the mobile device of the user.

11. The computer program product of claim 8, wherein communicating with the third parties for completion of disbursement coordination for logistics of the travel or relocation further comprises identifying on the interactive real-time coordination calendar system a time and for the third parties completion of the disbursement coordination for logistics and contacting the third parties for completion of the disbursement coordination based on the interactive real-time coordination calendar system time for the third parties completion.

12. The computer program product of claim 8, wherein parsing tasks associated with the travel or relocation and communicate the tasks to the user or the other individuals via the interactive real-time coordination calendar system further comprises removing tasks off of the interactive real-time coordination calendar system of the user and/or the other individuals upon identification of completion of the tasks.

13. The computer program product of claim 8, wherein generating an interactive real-time coordination calendar system for storage and display on a mobile device further comprises identifying budget categories and presenting recommendations on travel or relocation.

14. The computer program product of claim 8, wherein presenting notifications of the logistics of the travel or relocation further comprises identifying utilities, amenities, and insurance for the relocation and presenting notification of new utilities, amenities, and insurance to third party provider for set up of user for the new utilities, amenities, and insurance at the relocation.

15. A computer-implemented method for location disbursement coordination, the method comprising:
providing a control device and control device housing comprising computing system comprising a computer processing device and a non-transitory computer readable medium, where the computer readable medium comprises configured computer program instruction code, such that when said instruction code is operated by said computer processing device, said computer processing device performs the following operations:
generating a database integration with communication linkages for disbursement coordination for travel or relocation;
identifying the travel or relocation requirements of a user and other individuals associated with the travel or relocation;
identifying logistics for the travel or relocation and store contact information for third parties performing the requirements of the logistics;
generating an interactive real-time coordination calendar system for storage and display on a mobile device;
communicating with the third parties for completion of disbursement coordination for logistics of the travel or relocation;
parsing tasks associated with the travel or relocation and communicate the tasks to the user or the other individuals via the interactive real-time coordination calendar system; and
presenting notifications of the logistics of the travel or relocation.

16. The computer-implemented method of claim 15, wherein parsing tasks associated with the travel or relocation and communicate the tasks to the user or the other individuals via the interactive real-time coordination calendar system further comprises identifying the other individuals associated with the travel or relocation and linking the interactive real-time coordination calendar system onto a mobile device associated with the other individuals.

17. The computer-implemented method of claim 16, wherein identifying the other individuals associated with the travel or relocation further comprises identifying individuals that are traveling or relocating with a user based on user input into the interactive real-time coordination calendar system, wherein communication with the mobile device associated with the other individual is performed by extracting the communication channel requirements for the mobile device associated with the other individual from the mobile device of the user.

18. The computer-implemented method of claim 15, wherein communicating with the third parties for completion of disbursement coordination for logistics of the travel or relocation further comprises identifying on the interactive real-time coordination calendar system a time and for the third parties completion of the disbursement coordination for logistics and contacting the third parties for completion of the disbursement coordination based on the interactive real-time coordination calendar system time for the third parties completion.

19. The computer-implemented method of claim 15, wherein parsing tasks associated with the travel or relocation and communicate the tasks to the user or the other individuals via the interactive real-time coordination calendar system further comprises removing tasks off of the interactive real-time coordination calendar system of the user and/or the other individuals upon identification of completion of the tasks.

20. The computer-implemented method of claim 15, wherein generating an interactive real-time coordination calendar system for storage and display on a mobile device further comprises identifying budget categories and presenting recommendations on travel or relocation.
